(19) United States
(12) Patent Application Publication
(10) Pub. No.: US 2018/0202475 A1
(43) Pub. Date: Jul. 19, 2018

(54) HYDRAULIC ACTUATOR WITH MECHANICAL PISTON POSITION FEEDBACK

(71) Applicant: General Electric Company, Schenectady, NY (US)

(72) Inventors: Bodhayan Dev, Niskayuna, NY (US); Andrew Thomas Cross, Waterford, NY (US); Daniel Alan Brue, Edmond, OK (US); Brian Paul Reeves, Edmond, OK (US); Deepak Trivedi, Halfmoon, NY (US)

(21) Appl. No.: 15/409,367

(22) Filed: Jan. 18, 2017

(51) Int. Cl. F15B 15/28; F15B 11/10; F15B 1/027; E21B 43/12; E21B 34/06

(52) U.S. Cl. CPC F15B 15/2807; F15B 11/10; F15B 1/027; F15B 2211/7725; E21B 34/06; F15B 2211/424; F15B 2211/7053; E21B 43/121

(57) ABSTRACT

A hydraulic actuator for a downhole pump system includes a piston housing having a head end and a base end. A drive piston is movable within the piston housing between a first piston position proximate to the head end and a second piston position proximate to the base end. The hydraulic actuator includes a control valve that translates between a first control valve position in which fluid is directed into the base end and a second control valve position in which fluid is directed into the head. When the piston moves to the first piston position, a mechanical positon feedback system translates the control valve from the first control valve position to the second control valve position. When the piston moves to the second piston position, the mechanical positon feedback system translates the control valve from the second control valve position to the first control valve position.

### BACKGROUND

The field of the disclosure relates generally to oil and gas downhole pump assemblies and, more specifically, to hydraulic actuators for use in oil and gas pumping operations.

At least some known rod pumps are used in oil and gas wells, for example, to pump fluids from subterranean depths towards the surface. In operation, a pump assembly is placed within a well casing, well fluid enters the casing through perforations, and mechanical lift forces the fluids from subterranean depths towards the surface. For example, at least some known rod pumps utilize a downhole pump with complicated geometry, which by reciprocating action of a rod string, lifts the well fluid towards the surface.

In some known oil and gas well pump systems, one or more actuators may be used to facilitate the reciprocating action required for pumping fluid. In certain known systems, such actuators rely on one or more electronic components for providing power and/or control. However, due to the harsh conditions inherent in downhole pumping operations, electronic components can be subject to reduced reliability, significantly reducing the operational life of the actuator and increasing costs and downtime for repairs and replacements. Moreover, operators must rely on batteries with limited lifespans, expensive downhole generators, and/or long power supply lines to provide adequate power to the electronic components.

### BRIEF DESCRIPTION

In one aspect, a hydraulic actuator for a downhole pump is provided. The hydraulic actuator includes a piston housing having a head end and a base end opposite the head end. A drive piston disposed within the piston housing is movable between a first piston position proximate to the head end and a second piston position proximate to the base end. The hydraulic actuator further includes a control valve positionable between a first control valve position and a second control valve position. In the first control valve position, the control valve is configured to direct fluid into the base end, and in the second control valve position, the control valve is configured to direct fluid into the head end. The hydraulic actuator also includes a mechanical position feedback system configured to translate the control valve from the first control valve position to the second control valve position in response to the drive piston moving to the first piston position. The mechanical position feedback system further translates the control valve from the second control valve position to the first control valve position in response to the drive piston moving to the second piston position.

In a further aspect, a downhole pump system is provided. The downhole pump system includes a piston rod pump assembly and a hydraulic actuator coupled to the piston rod pump assembly. The hydraulic actuator includes a piston housing having a head end and a base end opposite the head end. A drive piston disposed within the piston housing is movable between a first piston position proximate to the head end and a second piston position proximate to the base end. The hydraulic actuator further includes a control valve positionable between a first control valve position and a second control valve position. In the first control valve position, the control valve is configured to direct fluid into the base end, and in the second control valve position, the control valve is configured to direct fluid into the head end. The hydraulic actuator also includes a mechanical position feedback system configured to translate the control valve from the first control valve position to the second control valve position in response to the drive piston moving to the first piston position. The mechanical position feedback system further translates the control valve from the second control valve position to the first control valve position in response to the drive piston moving to the second piston position.

In another aspect, a method of controlling a hydraulic actuator is provided. The hydraulic actuator includes a piston housing having a head end and a base end opposite the head end. The hydraulic actuator further includes a drive piston disposed within the piston housing and movable between a first piston position proximate to the head end and a second piston position proximate to the base end. The hydraulic actuator also includes a control valve positionable between a first control valve position and a second control valve position. In the first control valve position, the control valve directs fluid into the base end of the piston housing. In the second control valve position, the control valve directs fluid into the head end of the piston housing. The method includes determining, using a mechanical position feedback system, that the drive piston has moved into the second piston position. The method further includes transitioning, in response to determining that the piston has moved into the second position, the control valve from the second control valve position to the first control valve position. The method also includes determining that the piston has moved into the first piston position and transitioning, in response to determining that the piston has moved into the first piston position, the control valve from the first control valve position to the second control valve position.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective schematic illustration of an exemplary downhole pump system;

FIG. 2 is a schematic view of an exemplary hydraulic actuator that may be used in the downhole pump system of FIG. 1;

FIG. 3 is a schematic illustration of the hydraulic actuator shown in FIG. 2;

FIG. 4 is a schematic illustration of an alternative hydraulic actuator that may be used in the downhole pump system of FIG. 1;

FIG. 5 is a schematic illustration of another alternative hydraulic actuator that may be used in the downhole pump system of FIG. 1; and

FIG. 6 is a flow chart illustrating a method for controlling a hydraulic actuator, such as the hydraulic actuator of FIGS. 2 and 3.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The actuator assemblies and associated methods described herein facilitate extending pump operation in harsh oil and gas well environments. Specifically, actuator assemblies described herein include a control valve configured to induce reciprocating motion of piston assemblies. To do so, the control valve alternately directs pressurized hydraulic fluid into a head end and base end of the piston section, inducing corresponding movement of a drive piston disposed within the piston section. The control valve is switched between two configurations, each configuration corresponding to a different fluid flow path, in response to feedback provided by a mechanical position feedback system. The mechanical position feedback system is configured to induce transition of the control valve in response to the drive piston travelling to a first piston position corresponding to a head end of the piston section and a second piston position corresponding to a base end of the piston section.

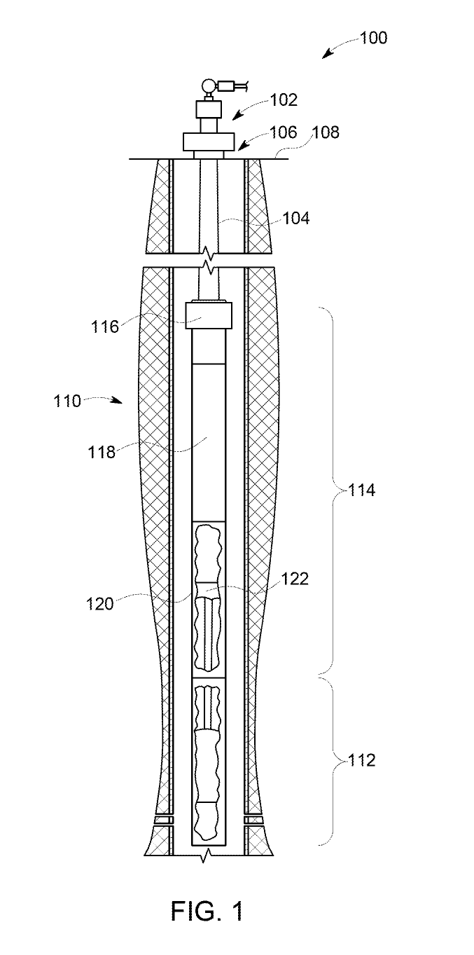

FIG. 1 is a perspective schematic illustration of an exemplary downhole pump system 100. In the exemplary embodiment, downhole pump system 100 includes a well head 102, production tubing 104 coupled to well head 102, and a pump assembly 110 coupled to production tubing 104 and positioned within a well bore 106. Well bore 106 is drilled through a surface 108 to facilitate the production of subterranean fluids such as, but not limited to, water and/or petroleum fluids. As used herein, “petroleum fluids” may refer to mineral hydrocarbon substances such as crude oil, gas, and combinations thereof

Pump assembly 110 includes a piston rod pump assembly 112 and a hydraulic actuator 114 configured to actuate piston rod pump assembly 112. Hydraulic actuator 114 generally includes a hydraulic power section 116, a control section 118, and a piston section 120. During operation, a drive piston 122 disposed within piston section 120 is driven by hydraulic power section 116 subject to control by control section 118. More specifically, power section 116 provides pressurized hydraulic fluid to drive piston 122 while control section 118 dynamically redirects the pressurized hydraulic fluid provided by power section 116 to facilitate reciprocation of drive piston 122.

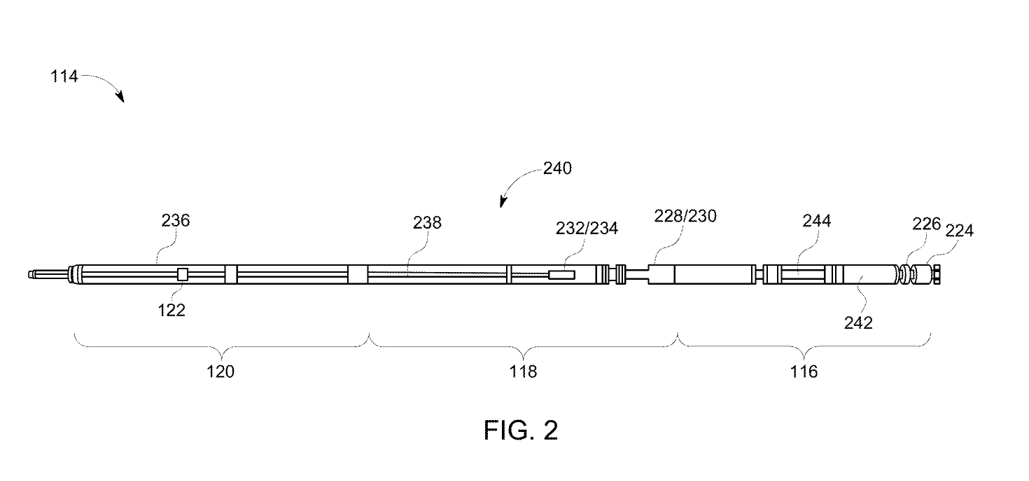

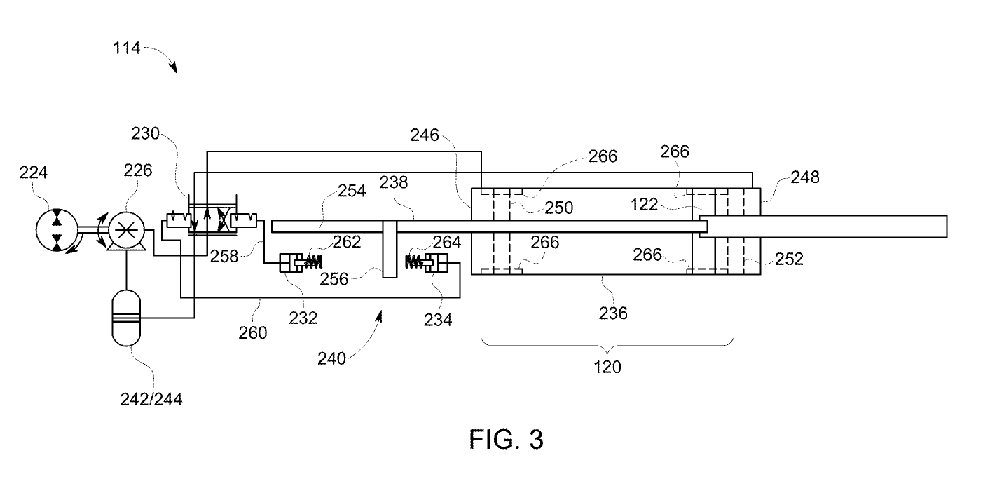

FIG. 2 is a schematic view of an exemplary hydraulic actuator 114 that may be used in downhole pump system 100 (shown in FIG. 1). FIG. 3 is a schematic illustration of hydraulic actuator 114. In the exemplary embodiment, hydraulic actuator 114 includes a power section 116, a control section 118, and a piston section 120. Power section 116 includes an actuator motor 224 and an actuator pump 226. Actuator pump 226 is coupled in fluid communication with control section 118 and, more specifically, a valve manifold 228 including a control valve 230 disposed within control section 118. Control section 118 further includes a first mini piston cylinder 232, a second mini piston cylinder 234, and a mechanical linkage 238. Together, first mini piston cylinder 232, second mini piston cylinder 234, and mechanical linkage 238 define a mechanical position feedback system 240 whose operation is discussed below in more detail in the context of FIG. 3. Hydraulic actuator 114 further includes piston section 120 including a piston housing 236 and drive piston 122 disposed within piston housing 236. In addition, hydraulic actuator 114 includes a compensator bag or compensator 244 that functions as a fluid volume storage device for hydraulic actuator 114 as well as actuator pump 226. Compensator 244 facilitates damping of pump pulsations transmitted through the fluid as well as energy storage, shock absorption, and other reservoir functions (e.g., fluid leakage make-up and fluid volume compensation due to temperature changes, etc.). In alternative embodiments, hydraulic actuator 114 further includes an accumulator 242 to facilitate accounting for variations in fluid volume during operation of hydraulic actuator 114, and in particular during a transition of control valve 230.

During operation, and with reference to FIG. 3, drive piston 122 reciprocates between a first piston position 250 proximate to a head end 246 of piston housing 236 and a second piston position 252 proximate to a base end 248 of piston housing 236. To facilitate reciprocation of drive piston 122, control valve 230 is configured to alternately direct fluid from actuator pump 226, which is driven by actuator motor 224, to head end 246 and base end 248 in response to the position of drive piston 122. More specifically, control valve 230 is configured to operate in a first control valve position in which pressurized fluid provided by actuator pump 226 is directed into head end 246 and a second control valve position in which the pressurized fluid is directed into base end 248. As the pressurized fluid is provided into head end 246, drive piston 122 is moved to second piston position 252 proximate to base end 248. Similarly, as the pressurized fluid is provided into base end 248, drive piston 122 is moved to first piston position 250 proximate to head end 246. Accordingly, as control valve 230 alternates between the first control valve position and the second control valve position, drive piston 122 reciprocates within piston housing 236.

Control valve 230 switches between the first control valve position and the second control valve position in response to position feedback provided by mechanical position feedback system 240. In the exemplary embodiment, mechanical position feedback system 240 includes a first mini piston cylinder 232, a second mini piston cylinder 234, and a mechanical linkage 238. Mechanical linkage 238 further includes a piston rod 254 coupled to drive piston 122 and an extension 256 coupled to piston rod 254. Accordingly, as drive piston 122 translates between first piston position 250 and second piston position 252, extension 256 similarly translates.

First mini piston cylinder 232 and second mini piston cylinder 234 are coupled in fluid communication with control valve 230 through a first hydraulic control line 258 and a second hydraulic control line 260, respectively. In the exemplary embodiment, control valve 230 is a two-position, detented, four-way directional valve. Alternatively, control valve 230 may be a three-position, detented, four-way valve or any other valve configuration that enables pump system 100 to function as described herein. In the exemplary embodiment, control valve 230 includes an internal mechanical detent that facilitates holding the valve in position until a minimum pilot fluid pressure is applied to a pilot port (not shown) of control valve 230. For example, in the exemplary embodiment, control valve 230 is switched between the first control valve position and the second control valve position by applying the minimum pilot fluid pressure to a pilot port, where control valve 230 remains in that position, with no pilot fluid pressure applied, until a new pilot fluid pressure signal is temporarily applied to the opposite pilot port. More specifically, control valve 230 is configured to transition into the first control valve position in response to a predetermined fluid pressure within first hydraulic control line 258, and to transition into the second control valve position in response to a predetermined fluid pressure within second hydraulic control line 260.

During operation, the predetermined fluid pressures within first hydraulic control line 258 and second hydraulic control line 260 are facilitated by extension 256 actuating first mini piston cylinder 232 and second mini piston cylinder 234, respectively. More specifically, first mini piston cylinder 232 and second mini piston cylinder 234 are disposed relative to each other and to extension 256 such that extension 256 actuates first mini piston cylinder 232 when drive piston 122 translates into first piston position 250, and actuates second mini piston cylinder 234 when drive piston 122 translates into second piston position 252.

In the exemplary embodiment, control valve 230 is configured to remain in position until the predetermined fluid pressure within one of first hydraulic control line 258 and second hydraulic control line 260 is achieved. Accordingly, control valve 230 continues to direct fluid into head end 246 and base end 248 until drive piston 122 is substantially in second piston position 234 and first piston position 232, respectively.

In certain embodiments, hydraulic actuator 114 includes features configured to reduce impact forces of components as drive piston 122 reciprocates within piston housing 236. For example, each of first mini piston cylinder 232 and second mini piston cylinder 234 include a spring 262 and 264, respectively, configured to facilitate decelerating first mini piston cylinder 232 and second mini piston cylinder 234 during actuation by extension 256. Similarly, piston housing 236 may further include deceleration features configured to decelerate drive piston 122 as it approaches head end 246 and base end 248. For example, piston housing 236 defines a plurality of longitudinal grooves 266 proximate to head end 246 and base end 248 such that as drive piston 122 approaches head end 246 and base end 248, a pressure differential across drive piston 122 is reduced due to leakage of the fluid through groove 266, causing deceleration of drive piston 122. In alternative embodiments, piston housing 236 includes other deceleration features for example, and without limitation, springs and bumpers disposed in head end 246 and base end 248 to facilitate deceleration of drive piston 122 and/or hydraulic cushioning features including a tapered piston bore and similar tapered features on drive piston 122.

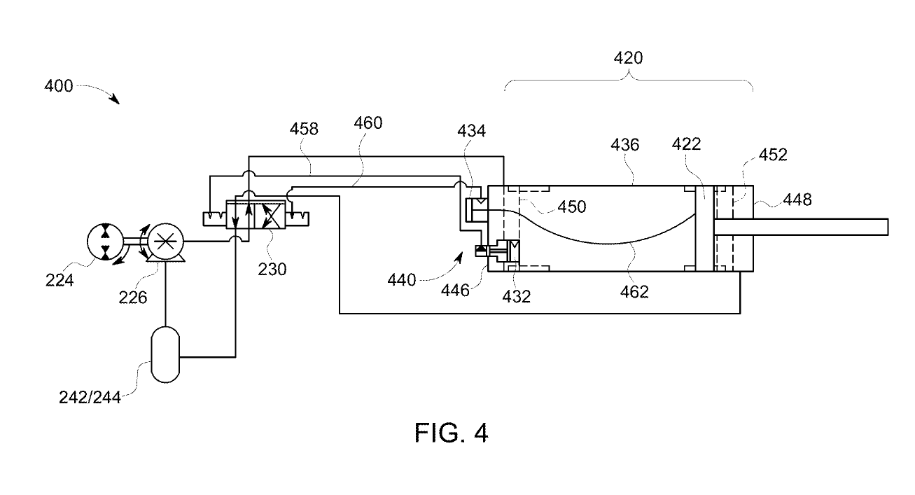

FIG. 4 is a schematic illustration of an alternative hydraulic actuator 400 that may be used in downhole pump system 100 (shown in FIG. 1). Hydraulic actuator 400 includes actuator motor 224 and actuator pump 226. Actuator pump 226 is coupled in fluid communication with control valve 230. Hydraulic actuator 400 further includes a first mini piston cylinder 432 and a second mini piston cylinder 434. Hydraulic actuator 400 further includes a piston section 420 including a piston housing 436 and a drive piston 422 disposed within piston housing 436. In the exemplary embodiment, hydraulic actuator 400 also includes compensator 244, which as described herein, functions as a fluid volume storage device for hydraulic actuator 400 as well as actuator pump 226. In alternative embodiments, hydraulic actuator 400 further includes an accumulator 242 to facilitate accounting for variations in fluid volume during operation of hydraulic actuator 400, and in particular during a transition of control valve 230. A cable 462 is disposed within piston housing 436 and coupled to drive piston 422 and to second mini piston cylinder 434. Together, first mini piston cylinder 432, second mini piston cylinder 434, and cable 462 define a mechanical position feedback system 440.

During operation, drive piston 422 reciprocates between a first piston position 450 proximate to a head end 446 of piston housing 436 and a second piston position 452 proximate to a base end 448 of piston housing 436. To facilitate reciprocation of drive piston 422, control valve 230 is configured to alternatively direct fluid from actuator pump 226 to head end 446 and base end 448 in response to the position of drive piston 422. More specifically, as described herein, control valve 230 is configured to operate in a first control valve position in which pressurized fluid provided by actuator pump 226 is directed into head end 446 and a second control valve position in which the pressurized fluid is directed into base end 448. As pressurized fluid is provided into head end 446, drive piston 422 is moved to second piston position 452 proximate to base end 448. Similarly, as pressurized fluid is provided into base end 448, drive piston 422 is moved to first piston position 450 proximate to head end 446. Accordingly, as control valve 230 alternates between the first control valve position and the second control valve position, drive piston 422 reciprocates within piston housing 436.

Control valve 230 switches between the first control valve position and the second control valve position in response to position feedback provided by mechanical position feedback system 440. In hydraulic actuator 400, mechanical position feedback system 440 includes first mini piston cylinder 432, second mini piston cylinder 434, and cable 462. First mini piston cylinder 432 and second mini piston cylinder 434 are coupled in fluid communication with control valve 230 through a first hydraulic control line 458 and a second hydraulic control line 460, respectively. Control valve 230 is further configured to switch into the first control valve position in response to a predetermined fluid pressure within first hydraulic control line 458 and to switch into the second control valve position in response to a predetermined fluid pressure within second hydraulic control line 460.

In the exemplary embodiment, first mini piston cylinder 432 and second mini piston cylinder 434 are disposed in head end 446 of piston housing 436, and actuate in response to drive piston 422 moving into first piston position 450 and second piston position 452. When actuated, first mini piston cylinder 432 causes an increase in pressure within first hydraulic control line 458. First mini piston cylinder 432 is configured to actuate by being depressed by drive piston 422 as drive piston 422 moves into first piston position 450. Similarly, second mini piston cylinder 434 is configured to cause an increase in pressure within second hydraulic control line 460 when actuated. Second mini piston cylinder 434 is configured to be actuated by being pulled by drive piston 422 as drive piston 422 moves into second piston position 452 by cable 462.

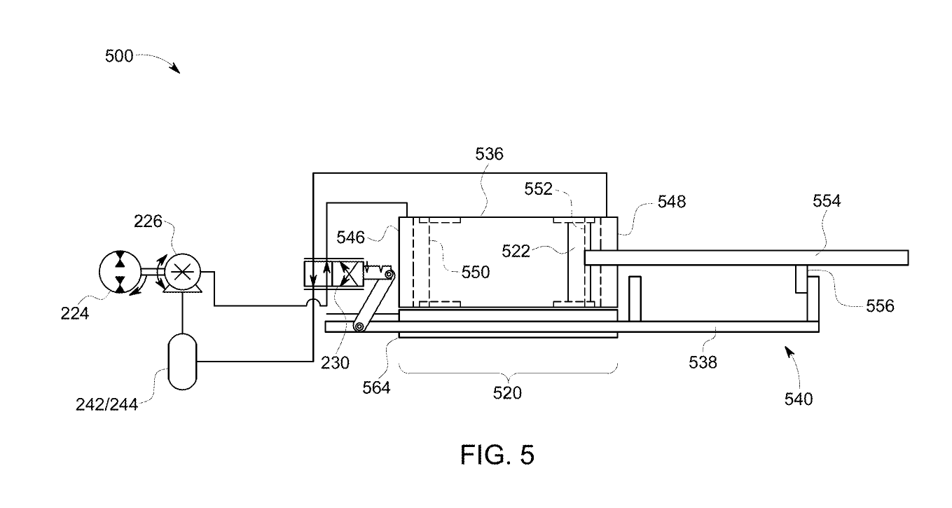

FIG. 5 is a schematic illustration of another alternative hydraulic actuator 500 that may be used in downhole pump system 100 (shown in FIG. 1). Hydraulic actuator 500 includes actuator motor 224 and actuator pump 226. Actuator pump 226 is coupled in fluid communication with control valve 230. Hydraulic actuator 500 also includes a piston section 520 including a piston housing 536 and a drive piston 522 disposed within piston housing 536. In the exemplary embodiment, hydraulic actuator 500 also includes compensator 244, which as described herein, functions as a fluid volume storage device for hydraulic actuator 500 as well as actuator pump 226. In alternative embodiments, hydraulic actuator 500 further includes an accumulator 242 to facilitate accounting for variations in fluid volume during operation of hydraulic actuator 500, and in particular during a transition of control valve 230. Piston section 520 further includes a piston rod 554 coupled to drive piston 522. Piston rod 554 is generally configured to transmit the reciprocating action of drive piston 522 to a piston rod pump assembly, such as piston rod pump assembly 112 (shown in FIG. 1). Piston rod 554 includes an extension 556 configured to actuate a mechanical linkage 538. Mechanical linkage 538 extends adjacent piston housing 536 and is coupled to control valve 230. Extension 556 and mechanical linkage 538 together define a mechanical position feedback system 540.

During operation, drive piston 522 reciprocates between a first piston position 550 proximate to a head end 546 of piston housing 536 and a second piston position 552 proximate to a base end 548 of piston housing 536. To facilitate reciprocation of drive piston 522, control valve 230 is configured to alternatively direct fluid from actuator pump 226 to head end 546 and base end 548 in response to the position of drive piston 522. More specifically, control valve 230 is configured to operate in a first control valve position in which pressurized fluid provided by actuator pump 226 is directed into head end 546 and a second control valve position in which the pressurized fluid is directed into base end 548. As the pressurized fluid is provided into head end 546, drive piston 522 moves to second piston position 552 proximate to base end 448. Similarly, as the pressurized fluid is provided into base end 548, drive piston 522 moves to first piston position 550 proximate to head end 546. Accordingly, as control valve 230 alternates between the first control valve position and the second control valve position, drive piston 522 reciprocates within piston housing 536.

Control valve 230 switches between the first control valve position and the second control valve position in response to position feedback provided by mechanical position feedback system 540. In hydraulic actuator 500, mechanical position feedback system 540 includes extension 556 and mechanical linkage 538. During operation, extension 556 contacts mechanical linkage 538 as drive piston 522 moves into first piston position 550 and second piston position 552, causing mechanical linkage 538 to translate. Due to the coupling of mechanical linkage 538 to control valve 230, translation of mechanical linkage 538 facilitates transition of control valve 230 between the first control valve position and the second control valve position. Furthermore, as described herein, control valve 230 includes an internal mechanical detent that facilitates holding the valve in position. In certain embodiments, mechanical linkage 538 is supported by a linear bearing 564 configured to maintain alignment and reduce friction during translation of mechanical linkage 538.

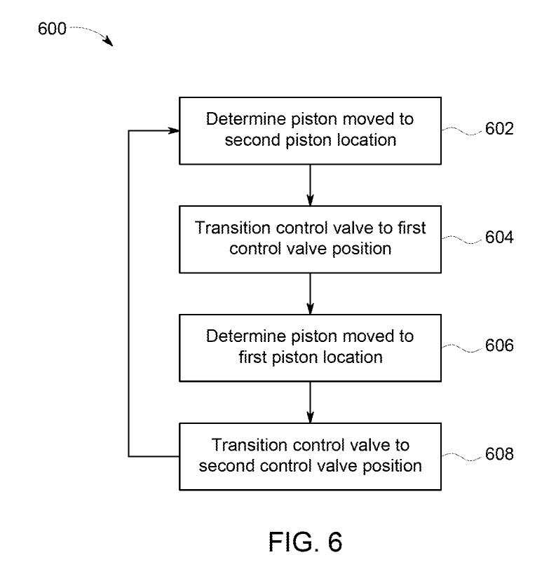

FIG. 6 is a flow chart illustrating a method 600 for controlling a hydraulic actuator, such as hydraulic actuator 114 (shown in FIGS. 2 and 3). With reference to FIG. 2, FIG. 3, and FIG. 6, as described herein, hydraulic actuator 114 generally includes piston housing 236 having head end 246 and base end 248 opposite head end 246, drive piston 122 disposed within piston housing 236 and movable between a first piston position 250 proximate to head end 246 and a second piston position 252 proximate to base end 248. Hydraulic actuator 114 further includes control valve 230, which is positionable between a first control valve position and a second control valve position. Control valve 230 is positionable between the first control valve position and the second control valve position based, at least in part, on position feedback provided by a mechanical position feedback system 240.

Method 600 includes determining 602, using mechanical position feedback system 240, that drive piston 122 has moved into second piston position 252. For example, in hydraulic actuator 114, mechanical position feedback system 240 includes extension 256 coupled to piston rod 254 that is in turn coupled to drive piston 122. As drive piston 122 moves into second piston position 252, extension 256 is configured to actuate first mini piston cylinder 232.

Method 600 further includes transitioning 604, in response to determining that drive piston 122 has moved into second piston position 252, control valve 230 into the first control valve position. In the first control valve position, control valve 230 is configured to direct fluid into base end 248 of piston housing 236. In hydraulic actuator 114, for example, first mini piston cylinder 232 is coupled to control valve 230 by a first hydraulic control line 258. Accordingly, when first mini piston cylinder 232 is actuated by extension 256, pressure within first hydraulic control line 258 is increased, facilitating transition of control valve 230 into the first control valve position.

Method 600 also includes determining 606, using mechanical position feedback system 240, that drive piston 122 has moved into first piston position 250. For example, in hydraulic actuator 114, as drive piston 122 translates into first piston position 250, extension 256 is configured to actuate a second mini piston cylinder 234.

Method 600 further includes transitioning 608, in response to determining that drive piston 122 has moved into first piston position 250, control valve 230 into the second control valve position. In the second control valve position, control valve 230 is configured to direct fluid into head end 246 of piston housing 236. In hydraulic actuator 114, for example, second mini piston cylinder 234 is coupled to control valve 230 by a second hydraulic control line 260. Accordingly, when second mini piston cylinder 234 is actuated by extension 256, pressure within second hydraulic control line 260 is increased, facilitating transition of control valve 230 into the second control valve position. As indicated in FIG. 6, after the step of transitioning 608 control valve 230 into the second control valve position, steps 602-608 may be repeated, thereby resulting in a reciprocating action of drive piston 122.

The actuator assemblies described herein facilitate extending pump operation in harsh oil and gas well environments. Specifically, the actuator assemblies described herein facilitate reciprocation of a drive piston using hydraulic power and a mechanical position feedback system. The mechanical positional feedback system is configured to translate a control valve to alternately direct fluid into a head end and a base end of a piston housing. As the drive piston reaches either the head end or the base end, the mechanical position feedback system switches the control valve to direct fluid into the piston housing to facilitate movement of the drive piston in the opposite direction.

An exemplary technical effect of the methods, systems, and section described herein includes at least one of: (a) improving reliability of actuator assemblies as compared to electronically controlled actuator assemblies; (b) improving the operational life of actuator assemblies; (c) improving the service life of downhole pump systems including actuator assemblies; and (d) reducing downhole pump operating costs.

Exemplary embodiments of methods, systems, and apparatus for actuator assemblies are not limited to the specific embodiments described herein, but rather, components of systems and/or steps of the methods may be utilized independently and separately from other components and/or steps described herein. For example, the methods, systems, and apparatus may also be used in combination with other pumping systems outside of the oil and gas industry. Rather, the exemplary embodiment can be implemented and utilized in connection with many other applications, equipment, and systems that may benefit from improved reciprocating actuator assemblies.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A hydraulic actuator comprising:
a piston housing having a head end and a base end opposite said head end;
a drive piston disposed within said piston housing and movable between a first piston position proximate to said head end and a second piston position proximate to said base end;
a control valve positionable between a first control valve position and a second control valve position, wherein:
in the first control valve position, said control valve is configured to direct fluid into said base end; and
in the second control valve position, said control valve is configured to direct fluid into said head end; and
a mechanical position feedback system configured to:
translate said control valve from the first control valve position to the second control valve position in response to said drive piston moving to the first piston position; and
translate said control valve from the second control valve position to the first control valve position in response to said drive piston moving to the second piston position.

2. The hydraulic actuator in accordance with claim 1, wherein said mechanical position feedback system comprises:
a first mini piston cylinder coupled in fluid communication with said control valve, said first mini piston cylinder configured to, when actuated, transition said control valve from the first control valve position to the second control valve position; and
a second mini piston cylinder coupled in fluid communication with said control valve, said second mini piston cylinder configured to, when actuated, transition said control valve from the second control valve position to the first control valve position.

3. The hydraulic actuator in accordance with claim 2, wherein said mechanical position feedback system further comprises a piston rod coupled to said drive piston, said piston rod comprising an extension disposed between said first mini piston cylinder and said second mini piston cylinder, wherein said extension is configured to:
actuate said first mini piston cylinder when said drive piston moves to the second piston position; and
actuate said second mini piston cylinder when said drive piston moves to the first piston position.

4. The hydraulic actuator in accordance with claim 2, wherein said second mini piston cylinder is disposed in said head end, wherein said mechanical feedback system further comprises a cable coupling said drive piston to said second mini piston cylinder, said cable configured to actuate said second mini piston cylinder by pulling said second mini piston cylinder in response to said drive piston moving to the second piston position.

5. The hydraulic actuator in accordance with claim 2, wherein each of said first mini piston cylinder and said second mini piston cylinder comprises a spring configured to decelerate said first mini piston cylinder and said second mini piston cylinder when actuated.

6. The hydraulic actuator in accordance with claim 1, wherein said mechanical position feedback system comprises:
a piston rod coupled to said drive piston, said piston rod comprising an extension; and
a mechanical linkage coupled to said control valve, said linkage configured to be actuated between a first linkage position and a second linkage position by said extension in response to said drive piston moving to the first piston position and the second piston position, respectively, wherein said mechanical linkage is configured to:
translate said control valve from the first control valve position to the second control valve position in response to said mechanical linkage translating to the first linkage location; and
translate said control valve from the second control valve position to the first control valve position in response to said mechanical linkage translating to the second linkage position.

7. The hydraulic actuator in accordance with claim 6, wherein said piston housing is disposed between said extension and said control valve, and said mechanical linkage extends proximate to said piston housing.

8. The hydraulic actuator in accordance with claim 1 further comprising at least one deceleration feature proximate to at least one of the first piston position and the second piston position.

9. The hydraulic actuator in accordance with claim 8, wherein said at least one deceleration feature comprises at least one of a groove defined by said piston housing, a spring, a hydraulic cushion, and a bumper.

10. The hydraulic actuator in accordance with claim 1, wherein said control valve comprises at least one of a two-position, detented, four-way directional control valve and a three-position, detented, four-way directional control valve.

11. The hydraulic actuator in accordance with claim 1 further comprising at least one of an accumulator and a compensator bag, coupled in fluid communication with said piston housing and said control valve.

12. The hydraulic actuator in accordance with claim 1 further comprising:
an actuator motor; and
an actuator pump coupled to said actuator motor and coupled in fluid communication with said control valve, said actuator pump configured to provide fluid to said control valve.

13. A downhole pump system comprising:
a piston rod pump assembly; and
a hydraulic actuator coupled to said piston rod pump assembly, said hydraulic actuator comprising:
a piston housing having a head end and a base end opposite said head end;
a drive piston disposed within said piston housing and movable between a first piston position proximate to said head end and a second piston position proximate to said base end;
a control valve positionable between a first control valve position and a second control valve position, wherein:
in the first control valve position, said control valve is configured to direct fluid into said base end; and
in the second control valve position, said control valve is configured to direct fluid into said head end; and
a mechanical position feedback system configured to:
translate said control valve from the first control valve position to the second control valve position in response to said drive piston moving to the first piston position; and
translate said control valve from the second control valve position to the first control valve position in response to said drive piston moving to the second piston position.

14. The downhole pump system in accordance with claim 13, wherein said mechanical position feedback system comprises:
a first mini piston cylinder coupled in fluid communication with said control valve, said first mini piston cylinder configured to, when actuated, transition said control valve from the first control valve position to the second control valve position; and
a second mini piston cylinder coupled in fluid communication with said control valve, said second mini piston cylinder configured to, when actuated, transition said control valve from the second control valve position to the first control valve position.

15. The downhole pump system in accordance with claim 14, wherein said mechanical position feedback system further comprises a piston rod coupled to said drive piston, said piston rod comprising an extension disposed between said first mini piston cylinder and said second mini piston cylinder, wherein said extension is configured to:
actuate said first mini piston cylinder when said drive piston moves to the second piston position; and
actuate said second mini piston cylinder when said drive piston moves to the first piston position.

16. The downhole pump system in accordance with claim 14, wherein said second mini piston cylinder is disposed in said head end, wherein said mechanical feedback system further comprises:
a cable coupling said drive piston to said second mini piston cylinder, said cable configured to actuate said second mini piston cylinder by pulling said second mini piston cylinder in response to said drive piston moving to the second piston position.

17. The downhole pump system in accordance with claim 14, wherein said mechanical position feedback system comprises:
a piston rod coupled to said drive piston, said piston rod comprising an extension; and
a mechanical linkage coupled to said control valve, said mechanical linkage configured to be actuated between a first linkage position and a second linkage position by said extension in response to said drive piston moving to the first piston position and the second piston position, respectively, wherein said mechanical linkage is configured to:
translate said control valve from the first control valve position to the second control valve position in response to said mechanical linkage translating to the first linkage location; and
translate said control valve from the second control valve position to the first control valve position in response to said mechanical linkage translating to the second linkage position.

18. A method of controlling a hydraulic actuator, the hydraulic actuator including a piston housing having a head end and a base end opposite the head end, a drive piston disposed within the piston housing and movable between a first piston position proximate to the head end and a second piston position proximate to the base end, and a control valve positionable between a first control valve position and a second control valve position, said method comprising:
determining, using a mechanical position feedback system, that the drive piston has moved into the second piston position;
transitioning, in response to determining that the drive piston has moved into the second piston position, the control valve from the second control valve position to the first control valve position, wherein in the first control valve position, the control valve directs fluid into the base end of the piston housing;
determining, using the mechanical position feedback system, that the drive piston has moved into the first piston position; and
transitioning, in response to determining that the drive piston has moved into the first piston position, the control valve from the first control valve position to the second control valve position, wherein in the second control valve position, the control valve directs fluid into the head end of the piston housing.

19. The method in accordance with claim 18, wherein the mechanical position feedback system includes a first mini piston cylinder coupled in fluid communication with the control valve and a second mini piston cylinder coupled in fluid communication with the control valve, said method further comprising:
actuating the first mini piston cylinder to transition the control valve from the first control valve position to the second control valve position; and
actuating the second mini piston cylinder to transition the control valve from the second control valve position to the first control valve position.

20. The method in accordance with claim 18, wherein the mechanical feedback system includes a mechanical linkage coupled to the control valve, said method further comprising:
actuating the mechanical linkage to a first linkage position to translate the control valve from the first control valve position to the second control valve position; and
actuating the mechanical linkage to a second linkage position to translate the control valve from the second control valve position to the first control valve position.
